(19) United States
(12) Patent Application Publication
(10) Pub. No.: US 2010/0270001 A1
(43) Pub. Date: Oct. 28, 2010

(54) System and method of maximizing grout heat conductibility and increasing caustic resistance

(76) Inventor: Michael J. Parrella, Weston, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/462,658

(22) Filed: Aug. 5, 2009

Related U.S. Application Data
(63) Continuation-in-part of application No. 12/456,434, filed on Jun. 15, 2009.
(60) Provisional application No. 61/137,956, filed on Aug. 5, 2008.
(60) Provisional application No. 61/137,974, filed on Aug. 5, 2008.
(60) Provisional application No. 61/137,955, filed on Aug. 5, 2008.
(60) Provisional application No. 61/137,975, filed on Aug. 5, 2008.

(51) Int. Cl. F24J 3/08; F28F 21/00; C04B 41/00

(52) U.S. Cl. 165/45; 165/185; 106/638

(57) ABSTRACT

A method of transferring heat using a grout that has been optimized for heat transfer includes a heat conductive particulate mixed with the grout. The grout and particulate mixture includes enough particulate to form connections to create heat conductive paths. A method of treating grout so that it is resistant to the caustic environment existing at the bottom of a well, mixing an aggregate with the grout to form a mixture having a PH opposite to the caustic environment at the bottom of the well.

### CROSS REFERENCE TO RELATED APPLICATIONS

This application is a continuation-in-part of United States Non-Provisional patent application Ser. No. 12/456,434 filed on Jun. 15, 2009. This application also claims priority to 1) U.S. Provisional Application No. 61/137,956, filed on Aug. 5, 2008; 2) U.S. Provisional Application No. 61/137,974, filed on Aug. 5, 2008; 3) U.S. Provisional Application No. 61/137,955, filed on Aug. 5, 2008; and 4) U.S. Provisional Application No. 61/137,975, filed on Aug. 5, 2008, the contents of all of which are hereby incorporated in their entirety.

### STATEMENT REGARDING FEDERALLY-SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates generally to the field of converting geothermal energy into electricity. More specifically, the present invention relates to capturing geothermal heat from deep within a drilled well and bringing this geothermal heat to the Earth's surface to generate electricity in an environmentally friendly process.

Wells that have been drilled for oil and gas exploration that are either depleted, or have never produced oil or gas, usually remain abandoned and/or unused and may eventually be filled. Such wells were created at a large cost and create an environmental issue when no longer needed for their initial use.

Wells may also be drilled specifically to produce heat. While there are known geothermal heat/electrical methods and systems for using the geothermal heat/energy from deep within a well (in order to produce a heated fluid (liquid or gas) and generate electricity therefrom), these methods have significant environmental drawbacks and are usually inefficient in oil and gas wells due to the depth of such wells.

More specifically, geothermal heat pump (GHP) systems and enhanced geothermal systems (EGS) are well known systems in the prior art for recovering energy from the Earth. In GHP systems, geothermal heat from the Earth is used to heat a fluid, such as water, which is then used for heating and cooling. The fluid, usually water, is actually heated to a point where it is converted into steam in a process called flash steam conversion, which is then used to generate electricity. These systems use existing or man made water reservoirs to carry the heat from deep wells to the surface. The water used for these systems is extremely harmful to the environment, as it is full of minerals, is caustic and can pollute water aquifers. Such deep-well implementations require that a brine reservoir exists or that a reservoir is built by injecting huge quantities of water into an injection well, effectively requiring the use of at least two wells. Both methods require that polluted dirty water is brought to the surface. In the case of EGS systems, water injected into a well permeates the Earth as it travels over rock and other material under the Earth's surface, becoming polluted, caustic, and dangerous.

A water-based system for generating heat from a well presents significant and specific issues. For example, extremely large quantities of water are often injected into a well. This water is heated and flows around the inside of the well to become heated and is then extracted from the well to generate electricity. This water becomes polluted with minerals and other harmful substances, often is very caustic, and causes problems such as seismic instability and disturbance of natural hydrothermal manifestations. Additionally, there is a high potential for pollution of surrounding aquifers. This polluted water causes additional problems, such as depositing minerals and severely scaling pipes.

Geothermal energy is present everywhere beneath the Earth's surface. In general, the temperature of the Earth increases with increasing depth, from 400°-1800° F. at the base of the Earth's crust to an estimated temperature of 6300°-8100° F. at the center of the Earth. However, in order to be useful as a source of energy, it must be accessible to drilled wells. This increases the cost of drilling associated with geothermal systems, and the cost increases with increasing depth.

In a conventional geothermal system, such as for example and enhanced geothermal system (EGS), water or a fluid (a liquid or gas), is pumped into a well using a pump and piping system. The water then travels over hot rock to a production well and the hot, dirty water or fluid is transferred to the surface to generate electricity.

As mentioned earlier herein, the fluid (water) may actually be heated to the point where it is converted into gas/steam. The heated fluid or gas/steam then travels to the surface up and out of the well. When it reaches the surface, the heated water and/or the gas/steam is used to power a thermal engine (electric turbine and generator) which converts the thermal energy from the heated water or gas/steam into electricity.

This type of conventional geothermal system is highly inefficient in very deep wells for several of reasons. First, in order to generate a heated fluid required to efficiently operate several thermal engines (electric turbines and generators), the fluid must be heated to degrees of anywhere between 190° F. and 1000° F. Therefore the fluid must obtain heat from the surrounding hot rock. As it picks up heat it also picks up minerals, salt, and acidity, causing it to very caustic. In order to reach such desired temperatures in areas that lack a shallow-depth geothermal heat source (i.e. in order to heat the fluid to this desired temperature), the well used must be very deep. In this type of prior art system, the geologies that can be used because of the need for large quantities of water are very limited.

The deeper the well, the more challenging it is to implement a water-based system. Moreover, as the well becomes deeper the gas or fluid must travel further to reach the surface, allowing more heat to dissipate. Therefore, using conventional geothermal electricity-generating systems can be highly inefficient because long lengths between the bottom of a well and the surface results in the loss of heat more quickly. This heat loss impacts the efficacy and economics of generating electricity from these types of systems. Even more water is required in such deep wells, making geothermal electricity-generating systems challenging in deep wells.

Accordingly, prior art geothermal systems include a pump, a piping system buried in the ground, an above ground heat transfer device and tremendous quantities of water that circulates through the Earth to pick up heat from the Earth's hot rock. The ground is used as a heat source to heat the circulating water. An important factor in determining the feasibility of such a prior art geothermal system is the depth of wellbore, which affects the drilling costs, the cost of the pipe and the size of the pump. If the wellbore has to be drilled to too great a depth, a water-based geothermal system may not be a practical alternative energy source. Furthermore, these water-based systems often fail due to a lack of permeability of hot rock within the Earth, as water injected into the well never reaches the production well that retrieves the water.

### BRIEF SUMMARY OF THE INVENTION

Wells that have been drilled for oil and gas exploration that are either depleted, or have never produced oil or gas, can now be used to generate electricity. Wells can also be drilled specifically for the purpose of generating electricity. The only requirement is that the wells are deep enough to generate heat from the bottom of the well.

Portions of the system requires the optimization of heat flow. The structural capacity of the grout is not important. The heat conductivity of the grout impacts the economics of the system for it is part of the system where heat is transferred from the geothermically active earth to the system. This invention optimizes the heat conductivity of the grout without considering its structural qualities.

The environment at the bottom of wells is sometimes very caustic. This invention also includes a grout that can be manufactured to resist the caustic nature of the well bottom.

Other embodiments, features and advantages of the present invention will become more apparent from the following description of the embodiments, taken together with the accompanying several views of the drawings, which illustrate, by way of example, the principles of the invention.

### BRIEF DESCRIPTION OF THE SEVERAL VIEWS OF THE DRAWING

FIG. 1 is a conceptual view of a system according to one embodiment of the present invention showing a single closed loop having a heat exchanging element where the heat conducting material and grout mate hot rock to the heat exchanging element;

FIG. 2 is a conceptual view of a system according to another embodiment of the present invention showing a particulate mixed with grout to connect and form heat conductive paths within the grout; and

FIG. 3 is a table of thermal conductivity ratings for various materials that may be used as particulate to mix with the grout.

### DETAILED DESCRIPTION OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

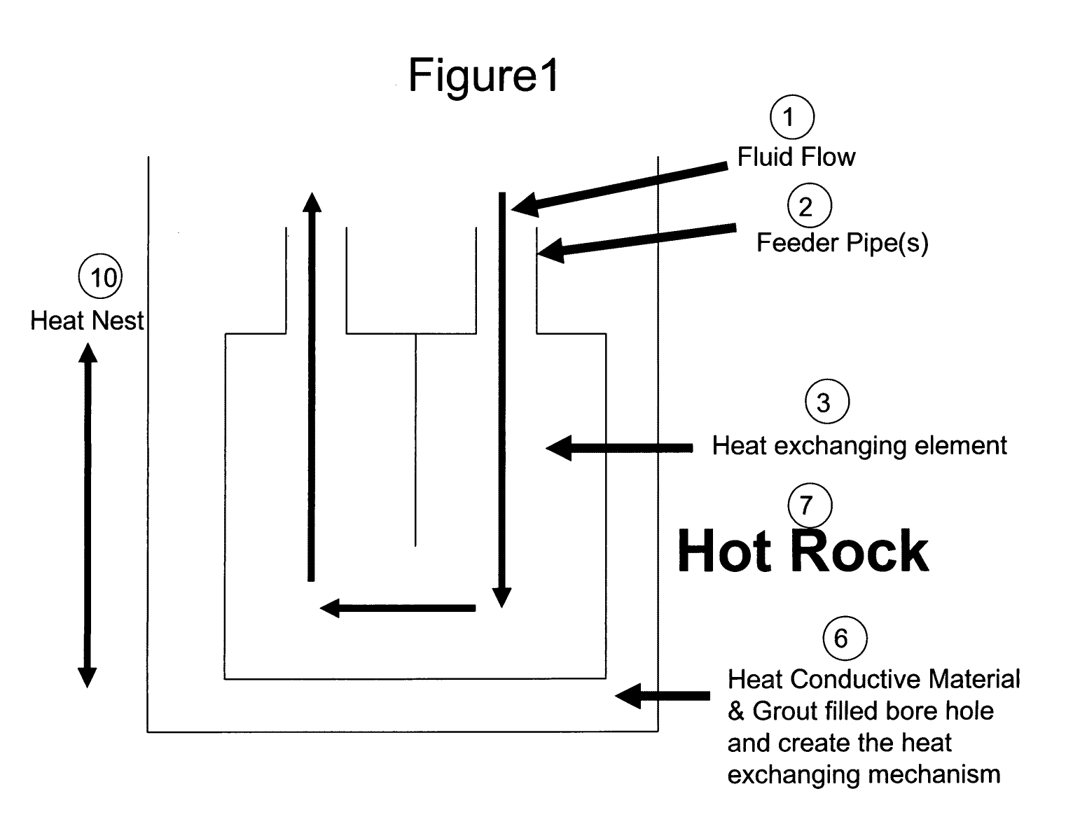

FIG. 1 illustrates a first preferred embodiment for the system of the present invention, wherein said system is comprised of a single closed loop having a heat exchanging element 3 where the heat conducting material and grout mate the hot rock 7 to the heat exchanging element.

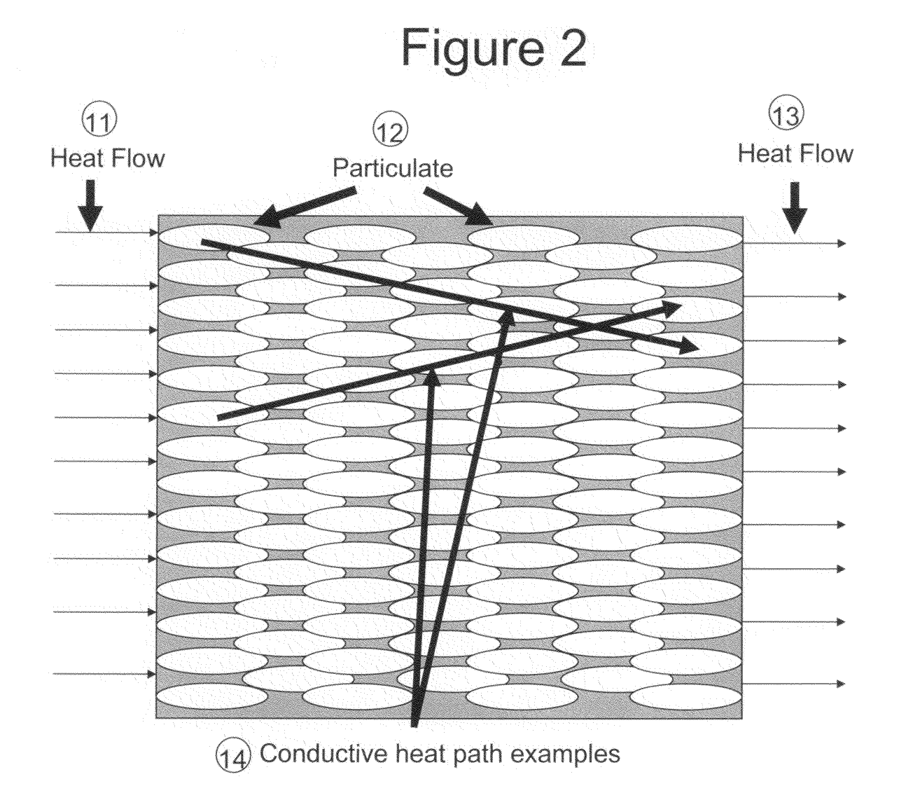

FIG. 2 illustrates a preferred embodiment for the grout where particulate is mixed with the grout and the particulate connects and forms heat conductive paths 14 within the grout.

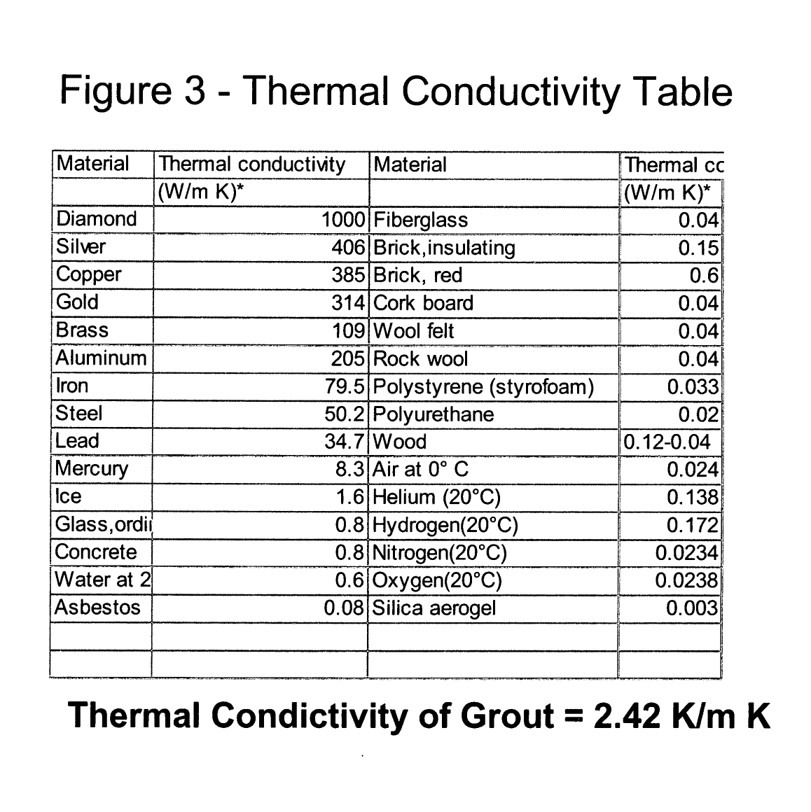

FIG. 3 illustrates a chart that shows thermal conductivity ratings for various materials that could be used as particulate to mix with the grout.

The system starts with a closed loop where a fluid (liquid or gas) 1 is piped (with one or more pipes) to a level of the well where there is heat that the system needs to bring to the surface.

At the heat point of the well (usually the bottom) the pipe(s) is attached to a heat exchanging element 3 that attaches to a pipe(s) that brings the heated fluid to the surface. The heat exchanging element 3 expedites the exchange of heat from the well to the heat transporting fluid. Heat conductive material and grout mates the heat exchanging element 6 to other heat conducting materials and the geothermically active hot rock.

The heat zone portion of the system needs the most optimized heat conducting material and grout 10.

Grouts were formulated to meet a number of criteria including thermal conductivity, coefficient of permeability, dimensional stability, durability, compatibility with conventional mixing and pumping equipment, environmental compliance and economics.

By using a heat conductive grout and adding ingredients one can improve the heat conductibility but may impact other aspects of the grout.

The heat nest 10 needs the most optimized thermal conductibility and can sacrifice other criteria of the grout. By mixing a particulate with the grout 12 that has a higher thermal conductivity than the grout you achieve an improved conductivity. If the particulate mixed with the grout stays in contact with each other it establishes an optimum conductive path 14 for the heat. The invention is creating a grout mixture that maximizes the thermal conductivity for the heat nest of a well for a heat exchanging element to maximize heat transfer.

The following formula assumes the iron filings connect to one another.

SC=(Y%×SG)+((1−Y%)×(n×SG)) Formula

Example using iron filings which has a thermal conductivity index of 79.5 which is 32 times more conductive than the 2.42 thermal conductivity of grout. For the calculation we use a 25% mixture of iron filings to grout.

SC=(75%×SG)+((1−75%)×32SG)

SC=8.75SG

We have improved the heat conductivity of the grout by 8.75 times. If the iron filings lose connectivity the multiplier of conductivity is reduced.

Additional additives mixed with the grout can make the grout resistant to the caustic environments of wells. If the well has an acidic environment the grout can be made to be alkaline. If the well is alkaline the grout can be made to be acidic. By making the grout opposite to the caustic nature of the environment, the grout protects the rest of the extraction system from the environment. This is accomplished by choosing the correct properties when manufacturing the grout.

It is to be understood that other embodiments may be utilized and structural and functional changes me be made without departing from the scope of the present invention. The foregoing descriptions of the embodiments of the invention have been presented for the purposes of illustration and description. It is not intended to be exhaustive or to limit the invention to the precise forms disclosed. Accordingly, many modifications and variations are possible in light of the above teachings. It is therefore intended that the scope of the invention not be limited by this detailed description.

1. A method of transferring heat using a grout that has been optimized for heat transfer, comprising:
a heat conductive particulate that is mixed with the grout, where the objective of the mixture is to have as much of the particulate as possible connect to each other creating heat conductive paths.

2. The system of claim 1, wherein the particulate is a metallic powder.

3. The system of claim 1, wherein the particulate is heat conductive rods.

4. The system of claim 1, wherein the particulate is a metallic ball (like a ball bearing).

5. The system of claim 1, wherein the particulate is a metallic bead.

6. The system of claim 1, wherein the particulate is ceramic.

7. The system of claim 1, wherein the particulate is a plastic.

8. A method of treating grout so that it is resistant to a caustic environment existing at the bottom of a well, comprising:
mixing grout with an aggregate to create mixture having an opposite PH from the caustic environment at the bottom of the well, wherein the aggregate is alkaline if the well environment is acidic, and the aggregate is acidic if the well environment is alkaline.
